(19) United States
(12) Patent Application Publication
(10) Pub. No.: US 2016/0118833 A1
(43) Pub. Date: Apr. 28, 2016

(54) Single to Multi Cell Charge Adapter & Method

(71) Applicant: Barron Greig, Tempe, AZ (US)

(72) Inventor: Barron Greig, Tempe, AZ (US)

(21) Appl. No.: 14/522,493

(22) Filed: Oct. 23, 2014

(51) Int. Cl. H02J 7/00

(52) U.S. Cl. CPC H02J 7/0086; H02J 7/0021; H02J 7/0019; H02J 7/0026; H02J 2007/0095

(57) ABSTRACT

A charging device comprising a microcontroller, a plurality of solid state relays, associated electronic components, a charging voltage source, and indicating light emitting diodes. A charging device is programmed to charge individual battery cells to completion and proceed sequentially to charge a plurality of battery cells and indicate charge status of each battery cell and indicate charge status of a plurality of battery cells.

### FIELD OF THE INVENTION

The present invention relates, in general, to battery cell charging devices and methods, to a novel device and method to charge battery cells.

More particularly, this invention relates to a device and method of charging battery cells, singularly or a plurality of battery cells.

### BACKGROUND OF THE INVENTION

Battery charging devices will charge battery cells but have limited sensitivity to individual cell charging status or amount of charge in individual cells. Battery charging devices have limited sensitivity to the charging status of a plurality of battery cells. Battery charging devices have limited monitoring sensitivity, in real time status, to determine if a particular and individual battery cell in a plurality of battery cells is performing to its charging capability as designed.

Accordingly, it would be advantageous to be able to charge single battery cells or a plurality of battery cells individually with monitoring of battery cells as they charge, to give feedback to the charging circuitry as it is charged and finally to give individual battery charging completion on an individual cell, indicating full charging status.

It would be advantageous to have a method to charge single battery cells or a plurality of battery cells individually with monitoring of the battery cells as they charge, to give feedback to the charging circuit as it is in charging mode and finally to give individual battery charging completion of an individual cell and a plurality of battery cells, indicating full charging status at completion of this battery cell charging method.

It is an object of the present invention to provide a new and improved battery charging device and method to charge a single battery cell, or a plurality of battery cells;

It is another object of the present invention to provide a new and improved battery charging device and method to charge a single battery cell, or a plurality of battery cells with individual battery cell monitoring through voltage status of a constant current battery charger;

It is a further object of the present invention to provide a charging circuit which derives its electrical power to operate from a battery charger without a dedicated separate power supply;

It is another object of the present invention to provide a battery charging device and method to monitor and charge a single battery cell, monitoring the charging process until the individual battery cell is charged to maximum voltage;

It is a further object of the present invention to provide a battery charging device and method that will charge an individual battery cell, and when the individual battery cell is charged to maximum voltage, to sequence monitoring and charging to the next battery cell in a plurality of battery cells;

It is still a further object of the present invention to provide a battery charging device and method that will charge individual battery cells and a plurality of battery cells and indicate charging status of individual battery cells;

It is still a further object of the present invention to provide a device and method of charging a single battery cell or a plurality of battery cells with a method of charging each individual battery cell independently and provide charging status of a plurality of battery cells;

It is a further object of the present invention to provide a method of charging battery cells connected in series, or unconnected;

A further object of the present invention is a battery charging method of charging battery cells of widely differing capacities;

It is still a further object to have method of charging battery cells with a charging method resilient to missing battery cells, wherein a battery charger will float to the maximum voltage where there is a missing cell in a plurality of battery cells and auto-selects the next battery cell.

### SUMMARY OF THE INVENTION

Briefly, to achieve the desired objects of the instant invention in accordance with a preferred embodiment thereof, provided is a charging device including a microcontroller chip, a plurality of solid state relays, associated electronic components, a charging voltage source, and indicating light emitting diodes. A charging device of the present invention is programmed to charge individual battery cells to completion and proceed sequentially to charge a plurality of battery cells and indicate charge status of each battery cell and indicate charge status of a plurality of battery cells. A charging device of the present invention needs no separate power supply, deriving power from a battery charger. A charging device of the present invention uses a method of charger voltage rise to auto select battery cells for charging.

### BRIEF DESCRIPTION OF THE DRAWINGS

The foregoing and further and more specific objects and advantages of the present invention will become readily apparent to those skilled in the art from the following detailed description of a preferred embodiment thereof taken in conjunction with the drawings, in which:

FIG. 1 is a schematic simplified drawing which illustrates a solid state relay used in a charging circuit of the present invention and its conventional mechanical relay equivalent;

FIG. 2 is a schematic simplified drawing which illustrates a microcontroller chip used in the charging circuit of the present invention with corresponding microcontroller chip voltage and input/output pins;

FIG. 3 is a schematic simplified drawing which illustrates a charging circuit of the present invention, illustrating a circuit configuration to charge a battery cell and illustrating a waveform showing a charging method for a plurality of battery cells;

FIG. 4 is a schematic simplified drawing which illustrates a charging circuit of the present invention, charging a single battery cell;

FIG. 5 is a schematic simplified drawing which illustrates a charging circuit of the present invention, charging a second battery cell;

FIG. 6 is a schematic simplified drawing which illustrates a charging circuit device of the present invention, charging a plurality of battery cells;

FIG. 7 is a schematic wiring diagram illustrating wiring contacts for individual components of a charging circuit device of the present invention.

### DESCRIPTION OF THE PREFERRED EMBODIMENT

In the preferred embodiment of the present invention “Single to Multi Cell Charge Adapter & Method” one objective is to charge a series connected battery comprising a plurality of battery cells C1 thru Cn. This series connected battery is to be charged using a single cell charger. A battery charging source is used to provide power to a charging circuit directly to a single cell in the plurality of cells, C1 thru Cn, via control of a microcontroller. This microcontroller is programmed with a method of charging and monitoring of battery cell charging status during the charging sequence on an individual battery cell in the plurality of battery cells of the series connected battery.

On initial power up of a charging circuit of the present invention, the microcontroller connects the charging circuit to cell C1 via a pair of solid state relays.

The microcontroller detects and measures its supply voltage, which is the voltage supplied by a single cell charger. As the cell charges, that voltage rises until it reaches a value, Vf at which the cell is considered to be fully charged. Vf is chemistry dependent and may be 3.6V for Lithium Iron Phosphate battery cells, or 4.1 V for Lithium Cobalt battery cells or some other programmable termination voltage up to the maximum voltage supported by the charger.

When Vf is reached for battery cell C1, Solid State Relays connecting battery cell C1 to the charging circuit are disabled and the Solid State Relay's for battery cell C2 are enabled resulting in charging of battery cell C2 being established. This process continues one battery cell at a time, until all battery cells in the plurality of battery cells have been charged and are then disconnected by control of the microcontroller through its internal charging program.

A microcontroller of the present invention is an integrated circuit that contains memory, processing units, and input/output circuitry in a single unit. Microcontrollers are purchased blank and then programmed with a specific control program, as with the method of charging battery cells of the present invention.

Once programmed a microcontroller is built into a battery charging device as described in the disclosure of the present invention.

A microcontroller of the preferred embodiment of the present invention comprises three different areas of memory: program memory, data memory, and RAM memory

Program memory is where a battery charging control program is stored. This is “Flash” rewritable memory that can be reprogrammed. This program is not lost when power is removed, so the program will start running again as soon as the power is reconnected.

Data memory is additional storage space within the microcontroller. This data is also not lost when power is removed.

RAM memory is used to store temporary data in variables as the battery charging program runs. This memory loses all data when power is removed. RAM variables are memory locations within the microcontroller that store data while the program is running. This information is lost when the microcontroller is reset.

A microcontroller of the preferred embodiment of the present invention can sink or source 20 mA on each output pin, maximum 90 mA per chip. Therefore low current devices such as LEDs can be interfaced directly to the output pins. Higher current devices such as a battery charging source of the present invention are interfaced via solid state relays. The embodiment of the present invention uses solid state relays to charge battery cells via control from a microcontroller.

A microcontroller operates by performing a large number of commands in a very short space of time by processing electronic signals. These signals are coded in the binary system, the signal either being high (1) or low (0).

In industry, microcontrollers are usually programmed using Assembler or “C” programming languages. However the complexity of these languages means that advanced training is required. Other programming systems use a bootstrap program in a blank microcontroller to use a higher level language that is more adaptable to users without the advanced software assembler languages. Both types of programming of a microcontroller will accomplish the objectives of the present invention,

The present invention uses an analog to digital converter integral to a microcontroller that detects source voltage status to send signals into the process block of a microcontroller. Output signals can be switched on and off by the process block of a microcontroller.

A microcontroller of the present invention uses information from an analog to digital converter to make decisions, based on its programming, to control output devices. These program decisions are made by a control program which is downloaded into the microcontroller. In the preferred embodiment of the present invention, the “Single to Multi Cell Charge Adapter & Method”, uses a standard microcontroller that has been programmed with a bootstrap code to accept basic commands into its control program.

In the preferred embodiment of the present invention, microcontroller 30 is of manufacture type such as Picaxe 14m2 series. It is to be understood that other manufacture types of microcontrollers can be suitable for the present invention.

Although this particular type of microcontroller is used in the preferred embodiment of the present invention, other types of microcontrollers and other assembler programming languages will accomplish the objectives of the present invention.

The preferred embodiment of the present invention uses a plurality of single-pole; normally open (1-Form-A) solid state relays that employ optically coupled MOSFET switch technology to provide high voltage input to output isolation.

In the preferred embodiment of the present invention, solid state relays are of manufacture type such as IXYS CPC 1907B series. It is to be understood, however, that other manufacture types of solid state relays can be suitable for the present invention.

Switching of a MOSFET switch is controlled by a photovoltaic die using OptoMOS architecture while activation of the output is controlled by a GaAIAs infrared LED. The combination of low on-resistance and high load current handling capabilities makes the relay suitable for battery charging switching applications.

An 8-pin, low profile Power SOIC package for high-current power solid state relays of the present invention, provides high voltage input to output isolation, while optically coupled circuitry provides noise immunity. The combination of low on-resistance and high load current handling capabilities makes this MOSFET switch suitable for a battery charging circuit of the present invention. Other solid state relays of varied pin and form factor manufacture can be suitable for the objectives of the present invention.

In the solid state relays of the present invention, input control current to the infrared LED for switching is 5 mA. This input control current is provided by a microcontroller through its battery charging program.

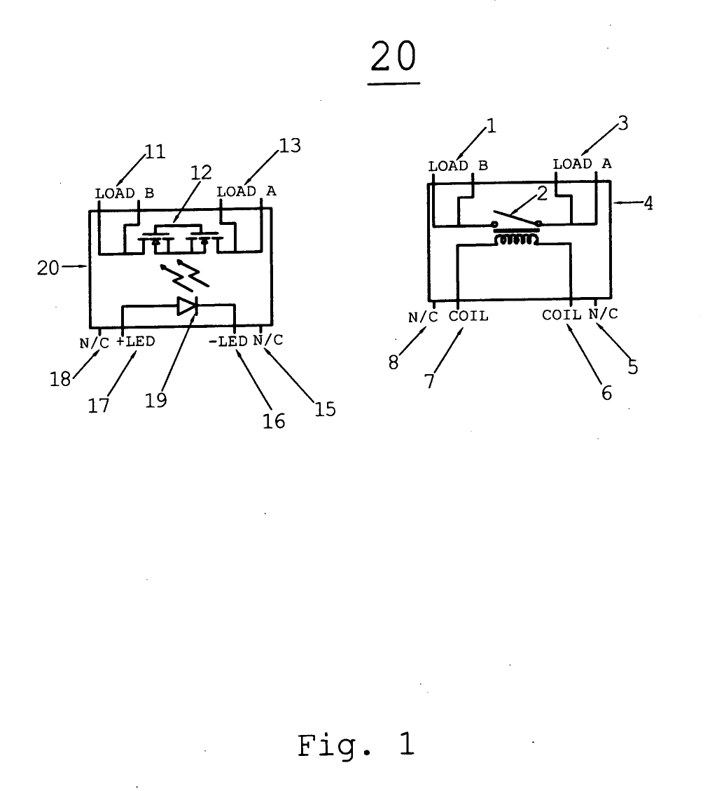

Turning now to the drawings in which like reference characters indicate corresponding elements throughout the several views, attention is first directed to FIG. 1 which illustrates a solid state relay 20 of the present invention. In a preferred embodiment of the present invention solid state relay 20 is of IXYS CPC1907B manufacture, although other similar manufacture types are suitable. FIG. 1 further shows a conventional relay 4 to illustrate the equivalent operation of solid state relay 20, equivalent in operation to transfer Load A 3 to Load B 1. Load A 3 comprises two connection points on conventional relay 4, connection points labeled as connection point 5 and connection point 6.

The activation of relay coil 2 will connect connection point 5 and connection point 6 to Load B 1 through connection point 7 and connection point 8.

In the present invention ‘Single to multi Cell Charger Adapter’ Load A 3 is a voltage and current source that will connect to Load B 1 through activation of relay coil 2.

Relay coil 2 is activated by a voltage current signal via coil signal 6 imposed on connection point 3, the signal further completed on connection point 2 to complete the flow of voltage and current to coil signal 7. Activation of coil 2 via coil signal 6 and coil signal 7 magnetizes coil 2 to close the circuit between Load A 3 and Load B 1.

FIG. 1 further shows a solid state relay 20 with its equivalent components to replicate the operation and mechanism of conventional relay 4 in the transfer of Load A 13 to Load B 11 of solid state relay 20.

Instead of a conventional relay coil 2 as illustrated in conventional relay 4, solid state relay 20 uses an infrared diode LED 19 activated via input LED signal 16 and completed at LED signal 17 via connection point 3 and connection point 2 on solid state relay 20. Input control current on LED signal 16 and LED signal 17 is approximately 5 mA to activate infrared diode LED 19.

Infrared diode LED 19 activates Double MOSFET switch 12 via infrared radiation from infrared diode LED 19.

FIG. 1 further shows solid state relay 20 to illustrate the transfer of Load A 13 to Load B 11. Load A 13 comprises two connection points on solid state relay 20, connection point 5 and connection point 6.

Activation of Double MOSFET switch 12 will connect connection point 5 and connection point 6 to Load B 11 through connection point 7 and connection point 8.

In the present invention ‘Single to Multi Cell Charger Adapter’ Load A 13 is a voltage and current source that will connect to Load B 11 through activation of Double MOSFET switch 12.

Double MOSFET switch 12 is activated by a voltage current signal via coil signal LED 16 imposed on connection point 3, the signal further completed on connection point 2 to complete the flow of voltage and current to signal LED 17. Activation of Double MOSFET switch 12 via signal LED 16 and signal LED 17 closes the circuit between Load A 13 and Load B 11.

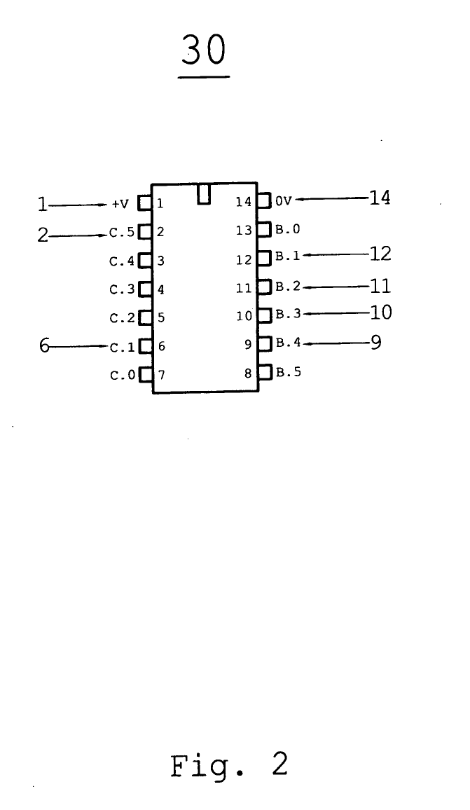

FIG. 2 illustrates a microcontroller chip 30 with a 14 pin configuration. Microcontroller chips are manufactured in various pin configurations. Microcontroller chip 30 of the preferred embodiment of the present invention ‘Single to Multi Cell Charger Adapter’ is a 14 pin integrated circuit microcontroller computer chip of Picaxe 14m2 manufacture, although other similar manufacture types are suitable.

On the left side of the illustration of FIG. 2, microcontroller chip 30 has contact pin one 1 through contact pin seven 7. Contact pin two 2 through contact pin seven 7 are input signal pins. Contact pin 1 is an input operation voltage positive connection to microcontroller chip 30. Contact pin 1 provides operating power and a reference voltage level to an internal operating program embedded in microcontroller chip 30. In the present configuration of the present invention only contact pin 2 and contact pin 6 are utilized as input pin connections.

On the right side of the illustration of FIG. 2 microcontroller chip 30 are contact pin eight 8 through contact pin fourteen 14. Pin 14 is a zero voltage pin and ground reference for scaling of voltage levels. Contact pin eight 8 through contact pin thirteen 13 are input/output signal pins. In the preferred embodiment of the present invention, only input/output contact pin nine 9 through contact pin twelve 12 are utilized.

In the preferred embodiment of the present invention, a program is embedded in microcontroller chip 30. Through control of output signals microcontroller chip 30 performs charging control of a plurality of battery cells, charging one battery cell at a time.

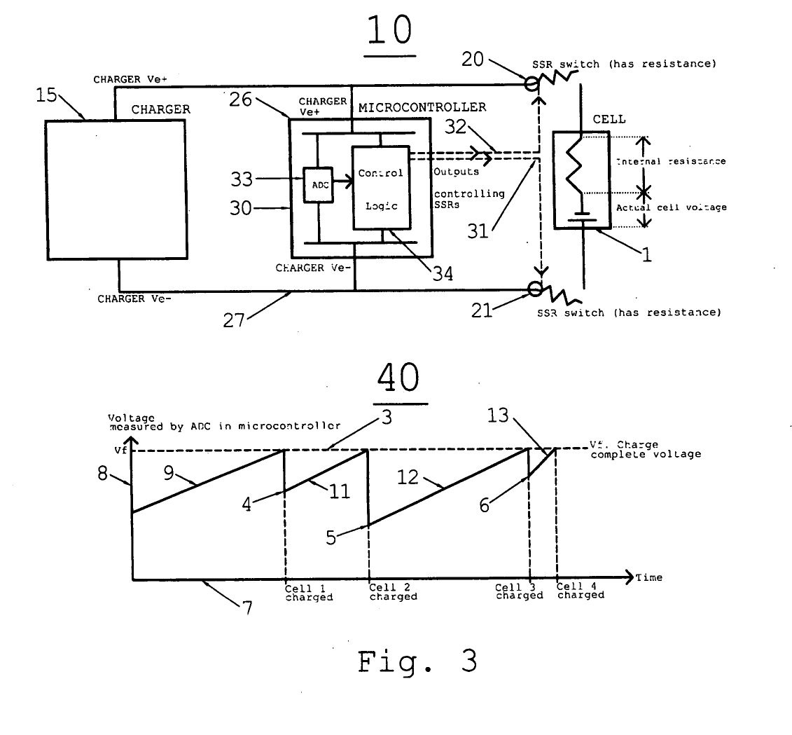

FIG. 3 illustrates a battery charging circuit 10 comprising a charger 15 supplying positive source voltage 26 and negative source voltage 27 to a microcontroller 30 and a battery cell. Microcontroller 30 is further shown comprising and an analog to digital converter ADC 33 and control logic 34.

Microcontroller chip 30 of the preferred embodiment of the present invention ‘Single to Multi Cell Charger Adapter’ is a 14 pin integrated circuit microcontroller computer chip of Picaxe 14m2 manufacture, although other similar manufacture types are suitable.

Battery cell 1 is charged via solid state relay 20 connected to positive source voltage 26 and solid state relay 21 connected to negative source voltage 27. Battery cell 1 is further shown to have internal resistance and capacitance which will vary according to how much electrical charge is delivered by charger 15 to battery cell 1.

Microcontroller 30 is further shown with an output enabling signal 32 and output enabling signal 31. Output enabling signal 32 will activate solid state relay 20 to conduct positive source voltage 26 to battery cell 1 by a method described in FIG. 1. Enabling signal 32 activates an internal electronic switch in solid state relay 20.

Output enabling signal 31 will activate solid state relay 21 to conduct negative source voltage 27 to battery cell 1, thereby completing an electrical charging circuit to battery cell 1. This initiates charging of battery cell 1 as further described through waveform 40 shown in FIG. 3. Waveform 40 has a vertical axis describing voltage and a horizontal axis describing time of charging of a plurality of battery cells.

In operation, charging of battery cell 1 continues until the charging voltage of battery cell 1 achieves a charging level voltage of Vf as shown in waveform 40.

Charger 15 is a constant current charger to charge battery cell 1. As resistance in battery cell 1 increases due to its increased charge, charger 15 continues to impress a constant current on battery cell 1. As the resistance of battery cell 1 increases, charger 15 will impose increased voltage to try to maintain constant current flow.

An increase in voltage from charger 15 is detected by the analog to digital converter ADC 33 of microcontroller 30. Analog to digital converter ADC 33 electronically conveys this increased voltage status to control logic 34 which then inactivates output signal 32 and output signal 31. Inactivation of output signal 32 turns off an internal switch in solid state relay 20 thereby disconnecting positive source voltage 26 from battery cell 1. Inactivation of output signal 31 turns off an internal electronic switch, described in FIG. 1, in solid state relay 21 thereby disconnecting negative source voltage 27 from battery cell 1. Charging of battery cell 1 is thereby complete.

As further shown in this disclosure, battery charging circuit 10 configuration of FIG. 3 can charge a plurality of battery cells, as shown in the illustration of waveform 40 of FIG. 3. Waveform 40 shows a charging method for battery cells 1 through 4.

Waveform 40 shows voltage 8 axis shown vertically against time 7 axis shown horizontally. Time 7 axis is time of charging of a plurality of battery cells.

As described in the charging of battery cell 1. An analog to digital converter ADC 33 sensed the increase in voltage of source voltage 26, shown in waveform 40 as voltage level Vf 3. When positive source voltage 26 reaches the voltage level of Vf 3, control logic 34 initiates inactivation of enabling signal 32 and enabling signal 31 thereby disconnecting battery cell 1 from charger 15.

As noted in waveform 40, voltage and time axis 4 denotes battery cell 1 is charged and the charging circuit then connects to battery cell 2 to continue the charging time increment 11 of waveform 40.

When time increment 11 reaches voltage Vf 3 then battery cell 2 is disconnected from charger 15. At voltage and time axis 5, battery cell 2 is charged and time increment 12 begins for charging of battery cell 3. When time increment 12 reaches voltage Vf 3, then battery cell 3 is charged and time increment 13 is initiated for battery cell 4 until voltage level Vf is achieved.

A novel feature of the present invention is operating electrical power of microcontroller 30. As shown in FIG. 3 microcontroller 30 attains it's operating electrical power from charger 15, thereby not needing its own and separate electrical power source.

In a further novel control feature of the present invention, when battery cell 1 is being charged, in order for current to flow, the voltage of charger 15 must be higher than the voltage of battery cell 1. When charger 15 is disconnected from charging circuit 10, the voltage to microcontroller 30 will drop slightly as to battery cell 1 voltage level. When microcontroller 30 detects this voltage drop through the analog to digital converter ADC 33, control logic 34 will inactivate output signal 32 and output signal 31, thereby opening the charging connections of solid state relay 20 and solid state relay 21 to battery cell 1. Since there is no operating electrical power to microcontroller 30 once charger 15 is disconnected, microcontroller 30 will shut down completely and not restart until charger 15 is reconnected.

In the preferred embodiment of the present invention, solid state relay 20 and solid state relay 21 are of manufacture type such as IXYS CPC 1907B series. It is to be understood, however, that other manufacture types of solid state relays can be suitable for the present invention.

Further, in the preferred embodiment of the present invention, microcontroller 30 is of manufacture type such as Picaxe 14m2 series. It is to be understood that other manufacture types of microcontrollers can be suitable for the present invention.

In further Figures of this disclosure, component parts such as resistors are suitable for the above series of solid state relays and microcontrollers; however these components parts will vary with other series of solid state relays or microcontrollers.

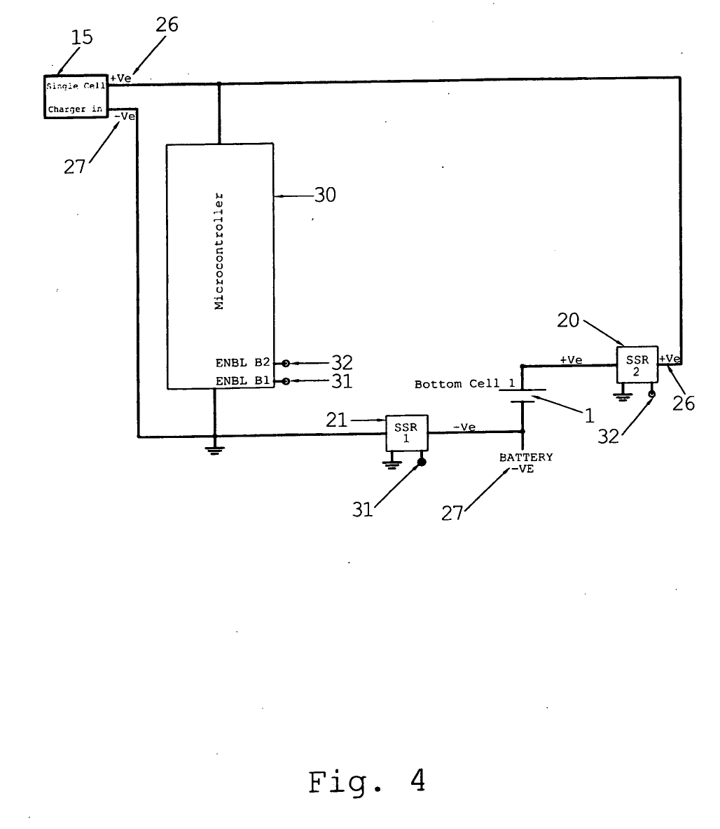

FIG. 4 illustrates a microcontroller chip 30 installed on a circuit board to provide a method of charging a battery cell 1 through a charging circuit comprising a positive voltage source Ve 26 and a corresponding negative voltage source Ve 27. A charging circuit is established between positive voltage source Ve 26 and negative voltage source Ve 27 to charge battery cell 1.

Further illustrated on microcontroller chip 30 is an output signal ENBL 31 and output signal ENBL 32 on microcontroller chip 30 contact point B1 and contact point B2.

Microcontroller 30 is further shown with an output enabling signal 32 and output enabling signal 31. Output enabling signal 32 will activate solid state relay 20 to conduct positive source voltage 26 to battery cell 1 by an electronic switch mechanism described in FIG. 1. Enabling signal 32 thereby activates an internal electronic switch in solid state relay 20.

Output enabling signal 31 will activate solid state relay 21 to conduct negative source voltage 27 to battery cell 1, thereby completing an electrical charging circuit to battery cell 1.

In operation, charging of battery cell 1 continues until the charging voltage of battery cell 1 achieves a charging level voltage of Vf as shown in waveform 40 of FIG. 3.

Charger 15 is a constant current charger to charge battery cell 1. As resistance in battery cell 1 increases due to its increased charge, charger 15 continues to impress a constant current on battery cell 1. As the resistance of battery cell 1 increases, charger 15 will impose increased voltage to try to maintain constant current flow.

An increase in voltage from charger 15 is detected by an analog to digital converter ADC 33 of microcontroller 30 as shown in FIG. 3. The analog to digital converter ADC 33 electronically conveys this increased voltage status to a control logic module 34 of microcontroller 30, also shown in FIG. 3, which then inactivates output signal 32 and output signal 31. Inactivation of output signal 32 turns off an internal electronic switch in solid state relay 20 thereby disconnecting positive source voltage 26 from battery cell 1. Inactivation of output signal 31 turns off an internal electronic switch, described in FIG. 1, in solid state relay 21 thereby disconnecting negative source voltage 27 from battery cell 1. Charging of battery cell 1 is thereby complete.

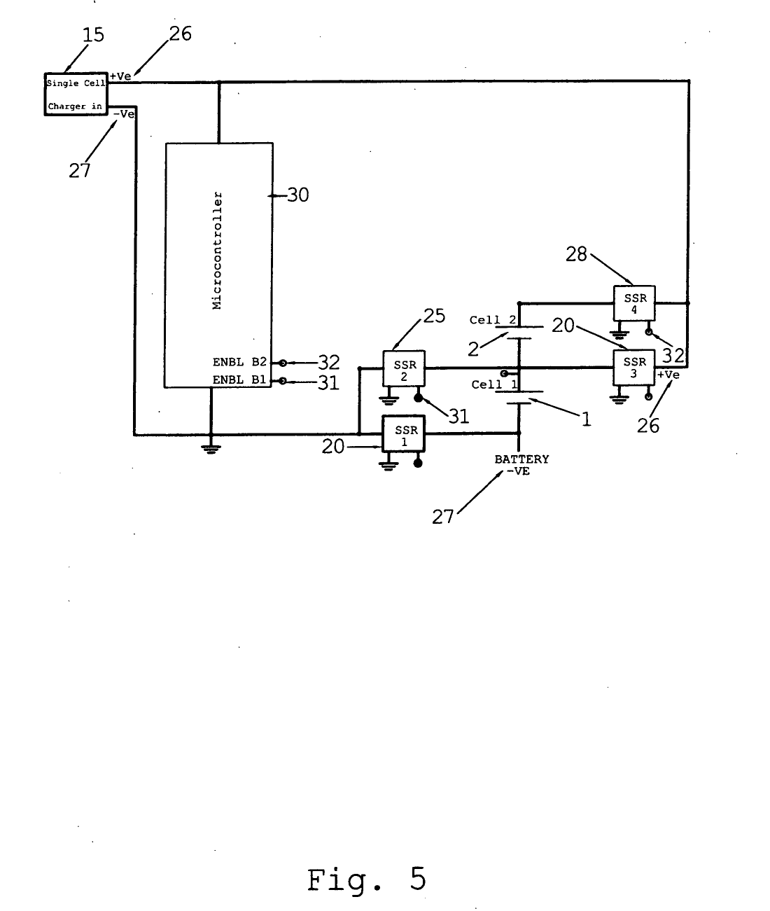

FIG. 5 illustrates a microcontroller chip 30 installed on a circuit board to provide a method of charging a battery cell 2 through a charging circuit comprising a positive voltage source Ve 26 and a corresponding negative voltage source Ve 27.

Illustrated on microcontroller chip 30 is output signal ENBL 31 and output signal ENBL 32 on microcontroller chip 30 contact point B1 and contact point B2.

Enabling signal ENBL 31 provides an electrical signal to solid state relay 25 engaged to negative voltage source Ve 27. Through an internal infrared LED, as illustrated in FIG. 1, solid state relay 25 switches to an “on” condition, providing contact to negative voltage source Ve 27 unto a negative contact on battery cell 2.

Simultaneously, enabling signal ENBL 32 provides an electrical signal to solid state relay 28 engaged to positive voltage source Ve 26. Through an internal infrared LED as illustrated in FIG. 1, solid state relay 28 switches to an “on” condition, providing contact to positive voltage source Ve 26 unto a positive contact on battery cell 2.

This “on” condition of both solid state relay 25 and solid state relay 28 continues as long as battery cell 2 voltage level is lower than positive voltage source Ve 26.

Microcontroller chip 30 internal analog to digital converter continues to monitor charger 15 positive voltage source 26 and continues to send enabling signal ENBL 31 and enabling signal ENBL 32 to respective solid state relay 25 and solid state relay 28 to maintain an “on” condition for charging of battery cell 2.

When microcontroller chip 30 detects positive voltage source 26 at an elevated level, microcontroller chip 30 disables signal ENBL 31 and signal ENBL 32. Without these enabling signals, solid state relay 25 and solid state relay 28 associated with negative voltage source Ve 27 and positive voltage source Ve 26 are turned to an “off” condition; solid state relay 25 and solid state relay 28 disengage the charging circuit to battery cell 2. Program logic turns to a next battery cell to perform the charging program.

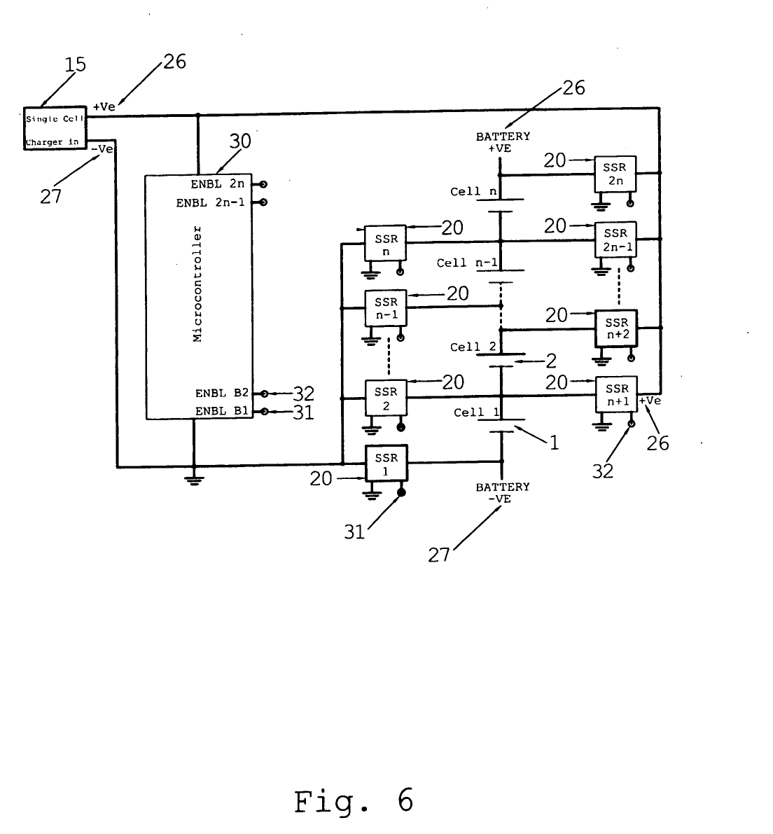

FIG. 6 illustrates a microcontroller chip 30 installed on a circuit board to provide a method of charging a plurality of battery cells through a charging circuit comprising a positive voltage source Ve 26 and a corresponding negative voltage source Ve 27. A charging circuit is established between positive voltage source Ve 26 and negative voltage source Ve 27 to charge a plurality of battery cells.

Illustrated on microcontroller chip 30 is an output signal ENBL 31 and signal ENBL 32 on microcontroller chip 30 contact point B1 and contact point B2. Output enabling signal ENBL 32 will activate solid state relay 20 to conduct positive source voltage 26 to battery cell 1 by an electronic switch mechanism described in FIG. 1.

Output enabling signal ENBL 31 will activate a solid state relay 20 to conduct negative source voltage 27 to battery cell 1, thereby completing an electrical charging circuit to battery cell 1.

In operation, charging of battery cell 1 continues until the charging voltage of battery cell 1 achieves a charging level voltage of Vf as shown in waveform 40 of FIG. 3.

Charger 15 is a constant current charger to charge battery cell 1. As resistance in battery cell 1 increases due to its increased charge, charger 15 continues to impress a constant current on battery cell 1. As the resistance of battery cell 1 increases, charger 15 will impose increased voltage to try to maintain constant current flow.

An increase in voltage from charger 15 is detected by an analog to digital converter of microcontroller 30 as shown in FIG. 3. The analog to digital converter electronically conveys this increased voltage status to a control logic module of microcontroller 30, also shown in FIG. 3, which then inactivates output signal 32 and output signal 31. Inactivation of output signal 32 turns off an internal electronic switch in solid state relay 20 thereby disconnecting positive source voltage 26 from battery cell 1. Inactivation of output signal 31 turns off an internal electronic switch, described in FIG. 1, in solid state relay 20 thereby disconnecting negative source voltage 27 from battery cell 1. Charging of battery cell 1 is thereby complete. Program logic turns to battery cell 2 to perform the charging program on battery cell 2.

Microcontroller chip 30 internal program continues in the above sequence, charging each battery cell in a plurality of battery cells.

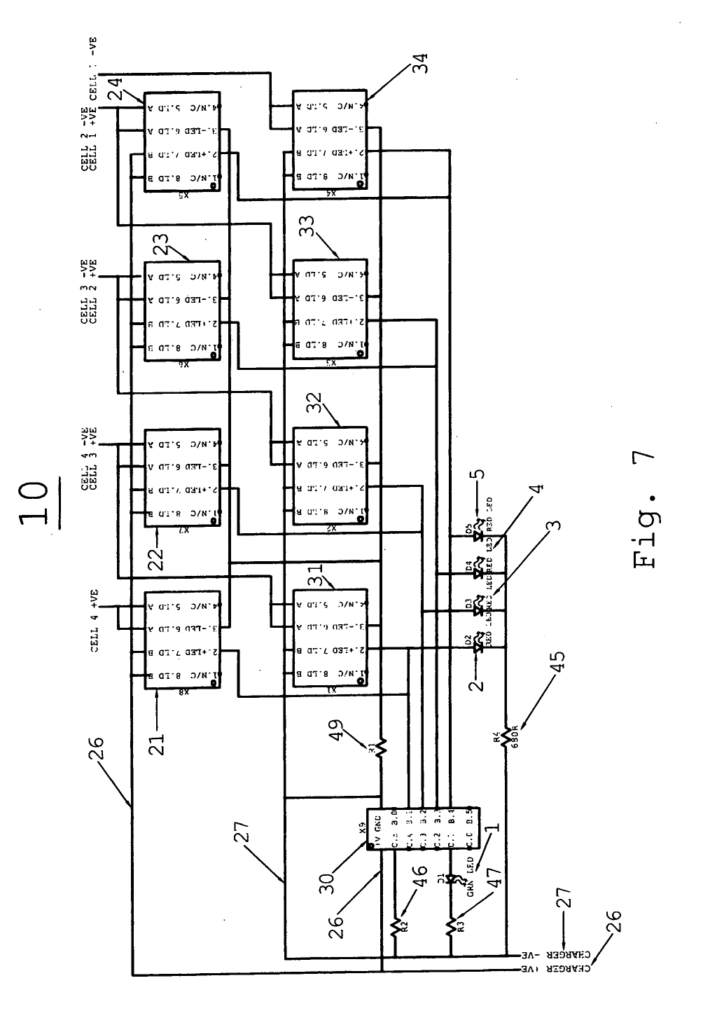

FIG. 7 illustrates a wiring diagram 10 of the present invention “Single to Multi Cell Charge Adapter & Method”. Major components illustrated are microcontroller chip 30 and solid state relays labeled 21 through 24 and 31 through 34.

In the preferred embodiment of the present invention, solid state relays 21 through 24 and 31 through 34 are of manufacture type such as IXYS CPC 1907B series. It is to be understood, however, that other manufacture types of solid state relays can be suitable for the present invention.

Further, in the preferred embodiment of the present invention, microcontroller 30 is of manufacture type such as Picaxe 14m2 series. It is to be understood that other manufacture types of microcontrollers can be suitable for the present invention.

In FIG. 7, component parts such as resistors are suitable for the above series of solid state relays and microcontrollers; however these resistor components parts will vary with other series of solid state relays or microcontrollers.

Positive voltage source Ve 26 provides a positive electrical connection to a pin designated +V on microcontroller chip 30. Positive voltage source Ve 26 also connects to pin C5 through a resistor R2 46, to microcontroller chip 30. Positive voltage source Ve 26 continues to connect to pin 7 and pin 8, designated LDB, on solid state relay 21 through solid state relay 24 on the wiring diagram.

Negative voltage source Ve 27 provides a negative voltage electrical connection to a pin designated C1, through resistor R3 45 and Green LED 1, to connect to microcontroller chip 30. Negative voltage source Ve 27 also connects to pin GND on microcontroller chip 30. Negative voltage source Ve 27 continues to connect to pin 7 and pin 8, designated LDB, on solid state relay 31 through solid state relay 34 on the wiring diagram.

Pin GND of microcontroller chip 30 connects through resistor 49 to pin 3 LED of solid state relay 21 through solid state relay 24, and to pin 3 LED on solid state relay 31 through solid state relay 34.

Turning attention now to pin B1 of microcontroller chip 30, pin B1 connects to pin 2 LED of solid state relay 21. Pin B1 further connects to pin 2 LED on solid state relay 31, and to Red LED 2. Red LED 2 further connects to negative voltage source 27.

Pin B2 of microcontroller chip 30 connects to Red LED 3 and pin 2 LED of solid state relay 22 and pin 2 LED of solid state relay 32.

Pin B3 of microcontroller chip 30 connects to Red LED 4 and to pin 2 LED of solid state relay 23 and pin 2 LED of solid state relay 33.

Pin B4 of microcontroller chip 30 connects to Red LED 5 and to pin 2 LED of solid state relay 24 and pin 2 LED of solid state relay 34.

In operation, microcontroller chip 30 detects positive source voltage Ve 26. If positive source voltage 26 is below a voltage Vf as shown in FIG. 3, microcontroller chip 30 sends an electrical signal voltage through pin B4 of microcontroller chip 30 to Red LED 5 and pin 2 LED on solid state relay 24 and to pin 2 LED of solid state relay 34. Also, a negative source voltage Ve 27 is sent from pin GND of microcontroller chip 30 through resistor 49 to pin 3 LED on solid state relay 24 and to pin 3 LED on solid state relay 34.

An infrared LED is activated between pin 2 LED and pin 3 LED on solid state relay 24. An infrared LED is also activated between pin 2 LED and pin 3 LED on solid state relay 34. Activation of the infrared LED, as illustrated in FIG. 1 connects negative voltage source Ve 27, through pin 5 LDA and pin 6 LDA of solid state relay 34, to a negative terminal of battery cell 1.

Activation of an infrared Led between pin 2 LED and pin 3 LED on solid state relay 24 connects positive source voltage 26 to pin 5 LDA and pin 6 LDA of solid state relay 24 and to a positive terminal of battery cell 1.

Through this electrical charging circuit between positive source voltage 26 and negative source voltage 27, battery cell 1 begins to charge. At the same time Red LED 5 is activated and lights “on” to indicate a battery cell 1 charging state.

On detection by microcontroller chip 30 of an elevated voltage in positive source voltage Ve 26, programming in microcontroller chip 30 will cease the “on” signal to the infrared LED's of solid state relay 24 and solid state relay 34, thereby shutting off both positive source voltage Ve 26 and negative source voltage Ve 27 to battery cell 1.

Programming of microcontroller chip 30 next directs charging of battery cell 2. The method described for charging of battery cell 1 is now duplicated for battery cell 2, with indicating Red LED 4 indicating charging status. This charging method continues for battery cell 2 through battery cell 4.

On completion of charging battery cell 1 through battery cell 4, microcontroller chip 30 sends an electrical signal to Greed LED 1 to activate to an “on” status and indicate all battery cells are charged. Green LED 1 electrical circuit connects to negative voltage source 27 via resistor R3 47.

Having fully described and disclosed the present invention and preferred embodiments thereof in such clear and concise terms as to enable those skilled in the art to understand and practice same,

the invention claimed is:

1. An electrical charging device, a control device, and a plurality of switching devices comprising:
a plurality of switching devices with each switching device having a first electrical circuit contact and a second electrical circuit contact;
a plurality of switching devices with each switching device having an internal electrical contact switch activated by an electrical signal from a control device;
a plurality of switching devices with a switching device having a first electrical circuit contact connected to a positive electrical voltage source from an electrical charging device;
a plurality of switching devices with a switching device having a second circuit contact connected to a positive terminal of a battery cell;
a plurality of switching devices with a switching device having a first electrical circuit contact connected to a negative voltage source from an electrical charging device;
a plurality of switching devices with a switching device having a second electrical circuit contact connected to a negative terminal of a battery cell;
an electrical charging device comprising a positive voltage source and a negative voltage source;
a control device comprising an analog to digital converter;
a control device comprising electrical signal outputs;
a control device comprising an internal program for sequencing of electrical signal outputs;
a control device comprising an internal program for detecting a source voltage from an electrical charging device and enabling electrical signal outputs to electrically charge an individual battery cell;
a control device comprising an internal program for detecting a source voltage and sequencing of electrical signal outputs by detecting an increase in source voltage from an electrical charging device to electrically charge a plurality of battery cells;
a control device comprising an internal program to indicate electrical charging status of an individual battery cell;
a control device comprising an internal program to indicate charging status of a plurality of battery cells.

2. An electrical charging device, a control device, and a plurality of switching devices as claimed in claim 1 wherein the plurality of switching devices include integrated circuit solid state relay devices.

3. An electrical charging device, a control device, and a plurality of switching devices as claimed in claim 1 wherein the plurality of switching devices include an integrated circuit solid state relay device with a first electrical contact and a second electrical contact.

4. An electrical charging device, a control device, and a plurality of switching devices as claimed in claim 1 wherein the plurality of switching devices include integrated circuit solid state relay devices with an internal switching circuit between a first electrical contact and a second electrical contact activated by an electrical signal from a control device.

5. An electrical charging device, a control device, and a plurality of switching devices as claimed in claim 1 wherein the plurality of switching devices include an integrated circuit solid state relay device with a first electrical contact connected to a positive voltage source from an electrical charging device.

6. An electrical charging device, a control device, and a plurality of switching devices as claimed in claim 1 wherein the plurality of switching devices include an integrated circuit solid state relay device with a second electrical contact connected to a positive terminal of a battery cell.

7. An electrical charging device, a control device, and a plurality of switching devices as claimed in claim 1 wherein the plurality of switching devices include an integrated circuit solid state relay device with a first electrical contact connected to a negative voltage source from an electrical charging device.

8. An electrical charging device, a control device, and a plurality of switching devices as claimed in claim 1 wherein the plurality of switching devices include an integrated circuit solid state relay device with a second electrical contact connected to a negative terminal of a battery cell.

9. An electrical charging device, a control device, and a plurality of switching devices as claimed in claim 1 wherein the plurality of switching devices include an integrated circuit solid state relay device wherein an electrical signal from a control device activates an internal electronic switch connecting a first electrical contact to a second electrical contact providing electrical positive voltage to a positive terminal of a battery cell.

10. An electrical charging device, a control device, and a plurality of switching devices as claimed in claim 1 wherein the plurality of switching devices include an integrated circuit solid state relay device wherein an electrical signal from a control device activates its internal electronic switch connecting a first electrical contact to a second electrical contact providing electrical negative voltage to a negative terminal of a battery cell thereby completing an electrical charging circuit to a battery cell.

11. An electrical charging device, a control device, and a plurality of switching devices as claimed in claim 1 wherein a control device is a microcontroller programmed with a battery charging program.

12. An electrical charging device, a control device, and a plurality of switching devices as claimed in claim 1 wherein status indicating devices are light emitting diodes.

13. An electrical charging device, a control device, and a plurality of switching devices as claimed in claim 1 wherein a control device is a microcontroller programmed with a battery charging program, deriving its operating electrical power from the electrical charging device, not needing a separate electrical power source;

14. An electrical charging device, a control device, and a plurality of switching devices as claimed in claim 1 wherein removal of electrical voltage from the electrical charging device will cease output signals from the control device to a plurality of switching devices, thereby disconnecting a charging circuit.

15. An electrical charging device and a plurality of switching devices comprising:
an electrical charging device comprising an electrical power source;
an electrical charging device further comprising an electrical control device;
an electrical charging device further comprising electrical indicating devices;
a switching device comprising a first contact electrically connected to a positive source voltage from an electrical power source;
a switching device comprising a second contact electrically connected to a negative source voltage from an electrical power source;
a voltage detection signal of an electrical power source by an electrical control device;
an output signal from an electrical control device to a switching device internal electronic switch;
an output signal from an electrical control device to a switching device internal electronic switch to connect a first contact to a second contact and to a positive terminal of a battery cell;
an output signal from an electrical control device to a switching device internal electronic switch to connect a first contact to a second contact and to a negative terminal of a battery cell;
a voltage detection signal indicating voltage level of an electrical power source by an electrical control device;
a voltage detection signal indicating a source voltage level to an electrical control device comparing to a voltage set point Vf programmed in the electrical control device, if below the set point the electrical control device continues to send an output signal to a plurality of switching device's internal electronic switch, if above set point, the output signals cease and an indicator signal is sent to an indicating device indicating full charge of a battery cell;
an electrical control device with an internal program to sequence the battery charging circuit to a next battery cell in a plurality of battery cells;
an electrical control device with an internal program to send an indicator signal to an indicating device upon completion of charging a plurality of battery cells.

16. An electrical charging device and a plurality of electrical switching devices as claimed in claim 13 wherein an electrical power source is a battery charging power supply.

17. An electrical charging device and a plurality of electrical switching devices as claimed in claim 13 wherein an electrical control device is a programmable microcontroller.

18. An electrical charging device and a plurality of electrical switching devices as claimed in claim 13 wherein a switching device is a solid state relay with MOSFET transistor switching to connect a first contact with a second contact on receiving an output signal from an electrical control device.

19. An electrical charging device and a plurality of electrical switching devices as claimed in claim 13 wherein Indicating devices are light emitting diodes.

20. A method of charging an individual battery cell or a plurality of battery cells comprising the steps of;
a) providing a switching device connected to a positive terminal of a battery cell;
b) providing a switching device connected to a negative terminal of a battery cell;
c) providing an electrical power source comprising a positive voltage source;
d) providing an electrical power source comprising a negative voltage source;
e) providing an electrical power source positive voltage source connected to a first contact of a switching device;
f) providing a second contact of a switching device connected to a positive battery terminal;
g) providing an electrical power source comprising a negative voltage source connected to a first contact of a switching device;
h) providing a second contact of a switching device connected to a negative battery terminal;
i) sending an electrical signal from an electrical control device to an internal switch of a switching device to connect a first contact to a second contact thereby connecting a positive voltage source to a positive terminal of a battery cell;
j) sending an electrical signal from an electrical control device to an internal switch of a switching device to connect a first contact to a second contact of a switching device thereby connecting a negative voltage source to a negative terminal of a battery cell;
k) measuring voltage level of a positive voltage source by means of an analog to digital converter internal to an electrical control device;
l) sending an output signal to a plurality of switching devices to maintain a charging circuit to a battery cell if a voltage level signal from an analog to digital converter is at normal source voltage level programmed in control logic of an electrical control device;
m) suspending an output signal from an electrical control device to a plurality of switching devices upon detecting an elevated positive voltage source level by the electrical control device and sending an indicating signal to an indicating device denoting full charge of a battery cell;
n) sequencing to a next battery cell, detecting normal positive voltage source level, thereby sending an output signal to a switching device with a first contact connected to a positive voltage source and a second contact connected to a positive terminal of a battery cell;
o) suspending an output signal by an electrical control device to a plurality of switching devices upon detecting an elevated positive voltage source level by the electrical control device and sending an indicating signal to an indicating device denoting full charge of a battery cell;
p) continuing sequencing of a plurality of battery cells with the above steps to charge all battery cells, sending an indicating signal to activate an indicating device indicating full charge to all battery cells.
